(19) United States
(12) Patent Application Publication
(10) Pub. No.: US 2015/0031796 A1
(43) Pub. Date: Jan. 29, 2015

(54) METHOD FOR MAKING FUNCTIONALIZED SILICA FOR RUBBER MASTERBATCH

(71) Applicant: LION COPOLYMER HOLDINGS, LLC, Geismar, LA (US)

(72) Inventors: Subir Debnath, Metairie, LA (US); Harold William Young, JR., Baton Rouge, LA (US)

(21) Appl. No.: 14/515,338

(22) Filed: Oct. 15, 2014

Related U.S. Application Data
(63) Continuation-in-part of application No. 13/658,376, filed on Oct. 23, 2012.
(60) Provisional application No. 61/594,259, filed on Feb. 2, 2012.

(51) Int. Cl. C09C 1/28; C08J 3/22

(52) U.S. Cl. CPC C09C 1/28; C08J 3/22; C08J 2309/06; C08J 2309/00; C08J 2307/00
USPC 523/351; 556/427

(57) ABSTRACT

A method for blending functionalized silica with styrene butadiene rubber or ethylene propylene diene monomer rubber can include silica and an organosilane chemically and covalently bound to a surface of the silica. The organosilane can be derived from an organic silane with a functional group. A silica rubber masterbatch for complexing with an emulsion styrene butadiene rubber latex, a synthetic polymer, a natural polymer, or combinations thereof can include the functionalized silica with the organosilane or a blend of organosilanes chemically and covalently bound to a surface of the silica. Each organosilane can have an average tetrameric structure having a T³/T² ratio of 0.3 to 0.9 or greater as measured by ²⁹Si silicon cross polarization magic angle spinning nuclear magnetic resonance.

### CROSS REFERENCE TO RELATED APPLICATION

The present application is a Continuation in Part of co-pending U.S. patent application Ser. No. 13/658,376 filed on Oct. 23, 2012, entitled “FUNCTIONALIZED SILICA FOR RUBBER MASTERBATCH”, which claims priority to and the benefit of U.S. Provisional Patent Application Ser. No. 61/594,259 filed on Feb. 2, 2012, entitled “FUNCTIONALIZED SILICA FOR RUBBER MASTERBATCH.” These references are hereby incorporated in their entirety.

### FIELD

The present embodiments generally relate to a method for making a functionalized silica for blending with styrene butadiene rubber or ethylene propylene diene monomer rubber that can include silica with an organosilane chemically and covalently bound to a surface of the silica, and to a silica rubber masterbatch for complexing with an emulsion styrene butadiene rubber latex, a synthetic polymer, a natural polymer, or combinations thereof that can include the functionalized silica.

### BACKGROUND

A need exists for a method for making a formulation that can be incorporated into styrene butadiene rubber (SBR), ethylene propylene diene monomer rubber (EPDM), or other synthetic polymers or natural polymers during an emulsion process that allows for efficient introduction of a silica filler therein to provide mixing and performance benefits.

A further need exists for a method for making a rubber composition that can be made using an emulsion SBR process with a silica rubber masterbatch having the functionalized silica.

A further need exists for a method for making a rubber composition having improved processability, filler dispersion, tear resistance, and wear resistance that includes a styrene butadiene copolymer rubber or a blend of the styrene butadiene copolymer rubber and another conjugated diene base rubber with the functionalized silica prepared using a silane coupling agent.

A further need exists for a pneumatic tire made by a method that creates a rubber composition with pretreated silica that is well dispersed homogeneously in the rubber formulation; thereby providing improved wet traction, improved wear, improved grip performance on dry surfaces, and improved rolling resistance.

The present embodiments meet these needs.

### BRIEF DESCRIPTION OF THE DRAWINGS

N/A

### DETAILED DESCRIPTION OF THE EMBODIMENTS

Before explaining the present composition in detail, it is to be understood that the composition is not limited to the particular embodiments and that it can be practiced or carried out in various ways.

The method of the invention is a method for making a functionalized silica in a dry process having a dry mixing a first silane coupling agent with a silica forming a functionalized silica.

The first silane coupling agent has an organosilane derived from an organic silane having the structure: Z₁Z₂Z₃Si(CH₂)_{y}X(CH₂)_{y}SIZ₁Z₂Z₃, wherein Z₁, Z₂, and Z₃ can each be independently selected from the group consisting of hydrogen, alkoxy, halogen, and hydroxyl, having the formula:

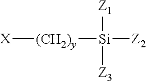

wherein X can be a functional group, including at least one of: an amino group, a polyamino alkyl group, a mercapto group, a polysulfide, a thiocyanoto group, an epoxy group, a halogen, an acryloxy group, a vinylic, a cycloalkyl, an aliphatic, an aromatic, and a methacryloxy group.

The method has the Y can be an integer equal to or greater than 0.

In the method a second silane coupling agent can be dry mixed simultaneously with the silica having the first silane coupling agent.

The second silane coupling agent can have an organosilane derived from an organic silane having the structure: Z₁Z₂Z₃Si(CH₂)_{y}X(CH₂)_{y}SIZ₁Z₂Z₃, and Z₁, Z₂, and Z₃ can each be independently selected from the group consisting of hydrogen, alkoxy, halogen, and hydroxyl, having the formula:

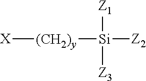

wherein X can be a functional group, including at least one of: an amino group, a polyamino alkyl group, a mercapto group, a polysulfide, a thiocyanoto group, an epoxy group, a halogen, an acryloxy group, a vinylic, a cycloalkyl, an aliphatic, an aromatic, and a methacryloxy group and the Y can be an integer equal to or greater than 0.

In the method, the Y can be an integer equal to or greater than 0.

In the method a plurality of silanes can be mixed with the silica for an amount of time, and at a temperature, to form the functionalized silica in a dry process.

In an embodiment, the method can include functionalized silica having an organosilane attached to a surface of the silica.

In an embodiment, the method can include using a silica with a specific surface area ranging from about 100 m2/gm to about 300 m2/gm, as measured by the Brunauer-Emmett-Teller analysis.

In an embodiment, the method can include using silica that is either a fumed silica or precipitated silica.

In an embodiment, the method contemplates that X of the formula, can be a vinyl group and Y can be an integer greater than zero.

In an embodiment, the method contemplates that the Z₁, Z₂, and Z₃ of the formula each can be independently selected from the following: hydrogen, C₁-C₁₈ alkyl, aryl, cycloalkyl, aryl alkoxy, and halo-substituted alkyl, and at least one of Z₁, Z₂, and the Z₃ can be an alkoxy, a hydrogen, a halogen, or a hydroxyl.

In an embodiment, the method can include simultaneously adding a third silane coupling agent while the first and second silane coupling agents are added to the silica.

In an embodiment, the method can include using a third silane coupling agent. The third silane coupling agent can be an ethanol free silane.

In an embodiment, the method can include using the first and second silane coupling agents in a 1:1 ratio.

In an embodiment, the method can include using at least two different organosilanes as the first and second silane coupling agents.

In an embodiment, the method can include using from 4 weight percent to 25 weight percent of organosilane per 100 weight percent of untreated silica to form the functionalized silica.

In an embodiment, the method can include adding 0.1 weight percent to about 10 weight percent of an acid or base to the formulation, the weight percent based on the total weight percent of the functionalized silica. The acid or base can be added during mixing to act as a catalyst to create the functionalized silica.

In an embodiment, the method can include blending the acid or base into the silica prior to adding the plurality of silane coupling agents.

In an embodiment, the method can include forming a silica rubber masterbatch component with the created functionalized silica component in a wet process for incorporation into an emulsion of a rubber component.

The method for forming the silica rubber masterbatch involves simultaneously adding components to the functionalized silica and emulsion of a rubber component.

First, 0.1 parts per hundred (phr) to about 35 phr of an oil extender based on the total weight of the masterbatch is added to the functionalized silica in the emulsion of rubber component. Simultaneously 0.2 weight percent to 1 weight percent of an antioxidant is added to the functionalized silica in the emulsion of rubber component with the oil extender, while simultaneously mixing the added components and coagulating under heat with an adjusted pH, forming the silica rubber masterbatch component.

In an embodiment, the rubber component in emulsion is at least one of: a natural rubber; a thermoplastic rubber; and a synthetic rubber.

The synthetic rubber can be at least one of: acrylonitrile butadiene rubber, acrylonitrile butadiene styrene rubber, carboxylated styrene butadiene rubber, carboxylated acrylonitrile butadiene rubber, styrene butadiene rubber, acrylonitrile butadiene rubber, polybutadiene rubber, polyisoprene rubber, polybutadiene isoprene rubber, a polymer of a conjugated diene, and a polymer of a vinyl monomer.

In an embodiment, the method can include using a polymer of a vinyl monomer or the polymer of a conjugated diene. The polymer of a vinyl monomer or the polymer of a conjugated diene can be a polyvinylchloride, a styrene acrylonitrile copolymer, or blends thereof.

In an embodiment, the method can include further simultaneously adding at least one of: 0.5 weight percent to 25 weight percent of a colorant based on the total weight of the masterbatch; 0.5 weight percent to 30 weight percent of a carbon black based on the total weight of the masterbatch; and 1 weight percent to 50 weight percent of a filler based on the total weight of the masterbatch to the emulsion of rubber with functionalized silica, oil extender and antioxidant.

In an embodiment, the method can use a filler that is at least one of a talc, clay or recycled rubber.

In an embodiment, the method can include mixing performed in at least one of: a ribbon mixer, an extruder, a stirred tank, a continuously stirred tank reactor, an expeller, and a devolatilizer.

In an embodiment, the method can include mixing performed in at least one of: sigma mixer, a ribbon blender, a low shear mixer.

The present embodiments generally relate to blending a functionalized silica into a silica rubber masterbatch that can be used to make a rubber composition and pneumatic tires.

With the functionalized silica, the silica has improved incorporation.

The functionalized silica can be added to the emulsion of rubber in a ribbon mixer or extruder and blending can be performed without causing silica dust to enter into the atmosphere; thereby creating a healthier work environment.

Pneumatic tires made using the rubber composition can have improved wet skid resistance, improved grip performance on dry road surfaces, lower rolling resistance, improved abrasion resistance, and can provide for improved fuel mileage and lower transportation costs. As such, auto manufacturers can more easily meet the corporate average fuel economy regulations for vehicle fleets and avoid associated fines, productivity of tire manufacturers can be increased due to improved incorporation of the silica into the rubber composition, and energy costs to make tires can be reduced.

The rubber composition can also be used to make other articles and transportation devices. For example, the rubber composition can be used to make rubber belts, rubber soled shoes, conveyor belts, carpets, hoses, and construction materials.

In one or more embodiments, the rubber composition can include a rubber component, such as a styrene butadiene copolymer rubber, or a blend of the styrene butadiene copolymer rubber and another conjugated diene base rubber.

Method to Prepare the Functionalized Silica Component

The functionalized silica can be prepared using a silane coupling agent with a silica.

The functionalized silica can include organosilane attached to a surface of a silica. In producing the rubber composition, after vulcanization the organosilanes can attach to a surrounding polymer or rubber matrix.

The silica can be a regular or highly dispersible precipitated silica with a specific surface area ranging from about 100 m2/gm to about 300 m2/gm, as measured by the Brunauer-Emmett-Teller analysis (B.E.T. surface area measurement technique).

The silica can be fumed silica or precipitated silica.

A silane usable with the silica as a coupling agent can be an organosilane derived from an organic silane having the structure: Z₁Z₂Z₃Si(CH₂)_{y}X(CH₂)_{y}SIZ₁Z₂Z₃. Within the structure, X can be a polysulfide, y can be an integer equal to or greater than 1, and Z₁, Z₂, and Z₃ can each be independently selected from the group consisting of hydrogen, alkoxy, halogen, and hydroxyl.

Other silanes usable with the silica as a coupling agent simultaneously with the first silane, can be an organosilane, which can be derived from an organic silane

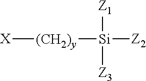

Within the structure above, the X can be a functional group, such as an amino group, a polyamino alkyl group, a mercapto group, a polysulfide, a thiocyanoto group, an epoxy group, a halogen, an acryloxy group, and a methacryloxy group and the Y can be an integer equal to or greater than 0.

The method can include while simultaneously dry mixing a second silane coupling agent with the silica having the first silane coupling agent. The second silane coupling agent comprising:

an organosilane derived from an organic silane having the structure: Z1Z2Z3Si(CH2)yX(CH2)ySIZ1Z2Z3, and Z1, Z2, and Z3 can each be independently selected from the group consisting of hydrogen, alkoxy, halogen, and hydroxyl, having the formula:

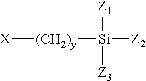

and wherein X can be a functional group, including at least one of: an amino group, a polyamino alkyl group, a mercapto group, a polysulfide, a thiocyanoto group, an epoxy group, a halogen, an acryloxy group, a vinylic, a cycloalkyl, an aliphatic, an aromatic, and a methacryloxy group and the Y can be an integer equal to or greater than 0.

In other embodiments, X can be a vinyl group and Y can be an integer greater than zero.

Within the structure above, the Z₁, Z₂, and the Z₃ can each be independently selected from the following: hydrogen, C₁-C₁₈ alkyl, aryl, cycloalkyl, aryl alkoxy, and halo-substituted alkyl. At least one of Z₁, Z₂, and the Z₃ can be an alkoxy, a hydrogen, a halogen, or a hydroxyl.

Different coupling agents can have different functionalities, such as one can be a mercapto, another can be a cycloalkyl. The coupling agents can be different functionalities selected from the group: polysulfide, mercapto, thiocyanato, halogen, amino, or aliphatic, aromatic, vinylic, cycloalkyl and combinations thereof.

A third silane can simultaneously be added to two selected silanes for use on the silica. The third coupling agent can be an ethanol free silane, such as those from the family of NXT™ silanes available from Momentive Performance Materials of Wilton, Conn.

In one or more embodiments, a single organosilane or multiple organosilanes can be used.

In embodiments, a blend of at least two different organosilanes or two different organosilanes can be used.

Embodiments of the invention include forming a functionalized silica for blending with organic polymers that includes from 0.1 weight percent to 25 weight percent of a plurality of silane coupling agents simultaneously on the silica.

Embodiments of the invention including that two organosilanes can be used in a 1:1 ratio.

The organosilane can be selected from the group consisting of: bis-(3-gamma-triethoxysilane silicon propyl)tetrasulfide], (3-Mercaptopropyl)trimethoxysilane, or combinations thereof; or a blend of at least two different organosilanes.

In embodiments, the functionalized silica can have from 25 weight percent of the organosilane per 100 weight percent of untreated silica.

In other embodiments, the functionalized silica can have from 4 weight percent to 17 weight percent of the organosilane per 100 weight percent of untreated silica.

In other embodiments, the functionalized silica can have from 6 weight percent to 10 weight percent of the organosilane per 100 weight percent of untreated silica.

In other embodiments, the functionalized silica can have from 4 weight percent to 25 weight percent of a plurality of organosilanes per 100 weight percent of untreated silica.

The organosilane can have up to three readily hydrolyzable groups attached directly to each silicon atom of the silica, and at least one organic group attached directly to each silicon atom.

The functionalized silica for use herein has an average tetrameric structure having a T³/T² ratio of 0.3 to 0.9 as measured by ²⁹Si cross polarization magic angle spinning nuclear magnetic resonance.

An acid or base can be added during mixing to act as a catalyst to create the functionalized silica. For example, an acetic acid can be used in an amount ranging from about 0.1 weight percent to about 10 weight percent. Another usable acid can also be carboxylic acid.

The base that can be added to the SBR latex can be a triethylamine, a trialkylamine, a monoalkalamine or dialkyl amines, or combinations thereof. The base can be added in an amount ranging from about 0.1 weight percent to about 10 weight percent.

In one or more additional embodiments, the acid can be added in an amount ranging from about 0.5 weight percent to about 5 weight percent of the untreated silica.

In one or more additional embodiments, the base can be added in an amount ranging from about 0.5 weight percent to about 5 weight percent of the untreated silica.

The acid or base can be blended into the silica, and then the silane can be added to an embodiment of the method.

The silane can be mixed for an amount of time, such as three hours, and at a temperature, such as 100 degrees Celsius (C.). The silane can be mixed in a ribbon blender or other mixer.

The silane, or mixture of silanes, can be added to the silica by spraying; thereby introducing the silane into the silica along with the acid or the base, simultaneously.

The silica and the silane can mix for a time ranging from about 30 minutes to about 5 hours at a temperature ranging from about 50 degrees Celsius to about 150 degrees Celsius.

Method to Create a Silica Rubber Masterbatch using the Functionalized Silica Described Above

The functionalized silica component can be incorporated into an emulsion of a rubber component, such as an emulsion of styrene butadiene rubber, to form the silica rubber masterbatch.

The pretreated silica, that is the functionalized silica component, can be added into an emulsion of the rubber component, such as an emulsion of SBR, which can also be known herein as “SBR latex”; thereby forming the silica rubber masterbatch, wherein SBR stands for a styrene butadiene rubber latex.

The rubber component can be a synthetic rubber in an emulsion. The synthetic rubber can be a polymer of a conjugated diene, a polymer of a vinyl monomer and blends thereof.

The rubber component can be a natural rubber or a thermoplastic rubber.

The synthetic rubbers can be a member of the following list: acrylonitrile butadiene rubber, acrylonitrile butadiene styrene rubber, carboxylated styrene butadiene rubber, carboxylated acrylonitrile butadiene rubber, styrene butadiene rubber, acrylonitrile butadiene rubber, polybutadiene rubber, polyisoprene rubber, polybutadiene isoprene rubber or combinations thereof.

A natural rubber can be used as the rubber components. The natural rubber can be derived from the sap of plants. For example, the sap of Hevea Brasiliensis, guayule, various species of Euphorbia, or species of Taxacum (dandelion) can be used as a source of natural rubber.

A thermoplastic rubber can be used such as a polychloroprene, neoprene, or blends thereof.

In one or more embodiments, the synthetic rubber can be a polymer of a conjugated diene, a polymer of a vinyl monomer, or blends thereof. The polymer of a vinyl monomer or a polymer of a conjugated diene can be a polyvinylchloride, a styrene acrylonitrile copolymer, or blends thereof.

Additional Method to Make Masterbatch

The method can include the silica rubber masterbatch further including from 0.1 parts per hundred rubber (phr) to about 35 phr based on the total weight of the masterbatch of an oil extender, such as napthenic oil. For example, the napthenic oil can be Ergon BO 300 made by Ergon.

For example, when the silica rubber masterbatch includes pretreated silica and SBR latex, the oil extender can be added in an amount ranging from about 0.1 parts per hundred rubber (phr) to about 35 phr.

An Exemplary Method to Make a Silica Rubber Masterbatch using the Functionalized Silica Described Above

The invention provides a dust free method to incorporate a functionalized silica into the rubber composition.

For example, in an embodiment, the method can include starting with a synthetic silica, such as HiSil 233 manufactured by PPG of Pittsburgh, Pa.

The silica is pretreated with two silane coupling agents, such as organosilanes.

For example, the organosilane known as Si69 can be used [CAS 40372-72-3], bis-(3-gamma-triethoxysilane silicon propyl)tetrasulfide as the first silane coupling agent.

The organosilane known as OTES (n-octyltriethoxysilane) from Gelest can be used as the second coupling agent.

The reason that two (or more) organosilanes are used is that one silane is added primarily to facilitate coupling between the silica and the polymer, while the other is added to modify the surface of the silica without introducing coupling between the silica and polymer. This allows control of the nature of the silica surface, i.e bond to the hydroxyl groups on the silica surface, and the coupling between silica and polymer independently.

Three silane coupling agents can be bonded to the untreated silica to form the functionalized silica.

As an example, 7 weight percent of a first coupling agent known as Si69 from Evonik Industries is added to 7 weight percent of a second silane coupling agent known as OTES from Gelest and 2 weight percent of a third silane coupling agent known as NXT silane from Momentive.

The silane coupling agent is loaded onto the silica surface. The functionalized silica is then used to achieve a desired mechanical performance for the final rubber composition or an article made therefrom.

The functionalized silica is added to an emulsion styrene butadiene.

In an embodiment, an oil extender can be added in an amount ranging from about 0.1 parts per hundred rubber (phr) to 35 phr of the silica rubber masterbatch to the emulsion with the functionalized silica and styrene butadiene rubber.

In other embodiments, the silica rubber masterbatch can include antioxidants, colorants, carbon black, reinforcing fillers, or combinations thereof.

In an embodiment, the silica rubber masterbatch can be blended by adding from 0.2 weight percent to 1 weight percent of an antioxidants, such as Santoflex 134PD from Flexsys America.

In another embodiment, the silica rubber masterbatch can be blended by adding from 0.5 weight percent to 25 weight percent of a colorant, such as Titanium dioxide.

In yet another embodiment, the silica rubber masterbatch can be blended by adding from 0.5 weight percent to 30 weight percent of a carbon black.

In still another embodiment, the silica rubber masterbatch can be blended by adding from 1 weight percent to 50 weight percent of other fillers such as talc, clays, or recycled rubber.

In operation, the blending of the materials can be done in a mixer, such as ribbon mixer, or the like.

Reaction to form the rubber can be complete in about 1 hour to 4 hours. The formed rubber can be repeatedly washed, then dried to remove about 90 percent of any water in the crumb rubber product.

Silane coupling agents have the ability to form a durable bond between organic and inorganic materials. Encounters between dissimilar materials often involve at least one member that's siliceous or has surface chemistry with siliceous properties; silicates, aluminates, borates, etc., are the principal components of the earth's crust. Interfaces involving such materials have become a dynamic area of chemistry in which surfaces have been modified in order to generate desired heterogeneous environments or to incorporate the bulk properties of different phases into a uniform composite structure.

The general formula for a silane coupling agent typically shows the two classes of functionality. X is a hydrolyzable group typically alkoxy, acyloxy, halogen or amine. Following hydrolysis, a reactive silanol group is formed, which can condense with other silanol groups, for example, those on the surface of siliceous fillers, to form siloxane linkages. Stable condensation products are also formed with other oxides such as those of aluminum, zirconium, tin, titanium, and nickel. Less stable bonds are formed with oxides of boron, iron, and carbon. Alkali metal oxides and carbonates do not form stable bonds with Si—O—. The R group is a nonhydrolyzable organic radical that may possess a functionality that imparts desired characteristics.

The final result of reacting an organosilane with a substrate ranges from altering the wetting or adhesion characteristics of the substrate, utilizing the substrate to catalyze chemical transformations at the heterogeneous interface, ordering the interfacial region, and modifying its partition characteristics. Significantly, it includes the ability to effect a covalent bond between organic and inorganic materials.

The plurality of silane agents of this invention are chosen based on: concentration of surface hydroxyl groups, type of surface hydroxyl groups, hydrolytic stability of the bond formed and physical dimensions of the silica.

The space between homogeneous phases is sometimes called the interphase. In this region there is a steep gradient in local properties of the silica. By treating a silica with silanes the interphase can acquire specific surface energy, partition characteristics, mechanical and chemical properties.

The plurality of silane treatment onto silica allow independent control on both the coupling between the polymer and filler for end use properties, and the hydrophobicity of the silica for improved incorporation into the polymer when coagulated with polymer latices. Use of the two different silanes to make a functionalized enables the formulator to control the type and quantity of cross linking in the final rubber formulation. For example, if only a polysulfide silane is used on the functionalized silica the resulting rubber formulation has a high modulus, high tensile strength and low elongation at break. If only a non-polysulfide silane is used, the functionalized silica would make a rubber formulation with low modulus, low tensile strength, and higher elongation at break than the functionalized silica with polysulfide silane. Advantageously use of plurality of silanes enables broader versatility in producing gaskets, belts, tires, shoe soles, or mechanical goods for the mining and automotive industry. For example, a functionalized silica with only 17 weight percent polysulfide containing silane incorporated into a styrene butadiene rubber formulation (SBR) results in a final Mooney Viscosity of 80 Mooney Units. In contrast a functionalized silica with 7 weight percent of a polysulfide containing silane with 10 weight percent of an octyltriethoxy silane incorporated into a styrene butadiene rubber formulation results in a final Mooney Viscosity of only 50.

An exemplary coupling agent is:
Coupling Agent Si-69

Chemical Name: Bis[3-(triethoxysilyl)propyl]tetrasulfide

Structural formula:

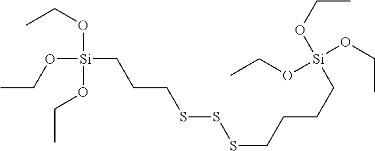 [SMILES: CCO[Si](CCCCSSSCCC[Si](OCC)(OCC)OCC)(OCC)OCC]

Molecular formula: C18H42O6Si2S4

Molecular weight: 538.94

CAS NO: 40372-72-3

| Item | Index |
|---|---|
| Appearance | Light yellow transparent liquid |
| Sulfur content %≧ | 22.0 |
| Flash point ° C. ≧ | 100.00 |
| Density g/cm3 (20° C.) | 1.070-1.120 |

Usable coupling agents can be Momentive (formerly OSi Specialties) Silquest A-1289, Dow Corning Z-6940, and ShinEtsu KBE-846.

### EXAMPLE 1

### Components of the Functionalized Silica

2273 grams of untreated silica is added to a mixer to create a functionalized silica.

45 grams of glacial acetic acid is added onto the silica in the mixer and mixed for 30 minutes.

159 grams of an organosilane known as Si69 from Evonik Industries AG is then added to the silica in the mixer.

159 grams of an organosilane known as OTES from Gelest is then added to the silica in the mixer.

The organosilane of this example has three readily hydrolyzable groups attached directly to each silicon atom of the silica and at least one organic group attached directly to each silicon atom.

Blending occurs for 2 hours at 100 degrees Celsius to 120 degree Celsius.

The reacted silane has an average tetrameric structure with a T³/T² ratio of 0.3 to 0.9 as measured by 29Si (silicon) cross polarization magic angle spinning nuclear magnetic resonance.

### EXAMPLE 2

### Components of the Silica Rubber Masterbatch

1340 grams of the functionalized silica formed in Example 1 is dispersed in 6700 grams of water in a high speed mixer for an hour to make a silica slurry.

9109 grams of emulsion styrene butadiene rubber latex with 21 percent solids, 8.47 grams of Santoflex 134PD antioxidant from Flexsys America LP as a 17 weight percent emulsion in water, and 593 grams of BO300 oil from Process Oils, Inc. are mixed for 5 minutes.

The functionalized silica of Example 1 is introduced into the latex, oil, and AO mixture and coagulated at 70 degrees Celsius at a pH of 3 under steady and gentle agitation to prepare the silica rubber master batch.

Table 1 depicts components of an example of a prepared masterbatch made by the method:

TABLE 1
ADDITIONAL STYRENE BUTADIENE RUBBER EXAMPLES

| | | | | Column 5 - | |
|---|---|---|---|---|---|
| | | | | weight percent | |
| Column 1 - | Column 2 - | Column 3 - | Column 4 - | of the rubber in | |
| component | trade name | vendor | phr | the masterbatch | |
| SBR latex | 1502 latex | Lion | 100 | 43.31 | wt. % |
| | | Copolymer | | | |
| 13% treated | Si69/NXT | Evonik/ | 90.4 | 39.15 | wt. % |
| silica | Silane | Momentive | | | |
| Staining oil | Hyprene | Process Oils, | 35 | 15.16 | wt. % |
| extender | BO300 | Inc. | | | |
| staining | Santoflex | Flexsys | 0.5 | 0.22 | wt. % |
| antioxidant | 134PD or | America | | | |
| | Flexzone | L.P. or | | | |
| | 11L | Chemtura | | | |
| N234 | Texas N234 | Sid | 5 | 2.17 | wt. % |
| Carbon black | | Richardson | | | |

| | |
|---|---|
| Total | Total weight |
| phr: 230.9 | percent: 100.0 |

Column 1 shows the components of the rubber composition. The 13 percent treated functionalized silica is made from untreated silica with Si69 as a first coupling agent and a second silane coupling agent known as NXT Silane from Momentive.

Column 2 shows trade names of the components of the rubber composition.

Column 3 shows a vendor of the components of the rubber composition.

Column 4 shows a phr of the components of the rubber composition.

Column 5 shows a weight percent of the components of the rubber composition.

The final row shows the total phr and the total weight percent.

For example, the SBR latex can be 1502 latex available from Lion Copolymer, LLC, and can have a phr of 100 and a weight percent of 43.31. The 1502 latex can have a 23 percent bound styrene with a Mooney viscosity of 45, as determined by the test ML 1+4 at 100 degrees Celsius.

Table 2 depicts components of an example of a rubber composition made with nitrile butadiene rubber (NBR) as the rubber component:

TABLE 2
NITRILE BUTADIENE RUBBER EXAMPLES

| | | | | Column 5 - | |
|---|---|---|---|---|---|
| | | | | weight percent | |
| Column 1 - | Column 2 - | Column 3 - | Column 4 - | of the rubber in | |
| component | trade name | vendor | phr | the masterbatch | |
| NBR latex | | | 100 | 43.31 | wt. % |
| 13% treated | Si69/OTES | Evonik/ | 90.4 | 39.15 | wt. % |
| silica | | Gelest | | | |
| Staining oil | Hyprene | Process Oils, | 35 | 15.16 | wt. % |
| extender | BO300 | Inc. | | | |
| staining | Santoflex | Flexsys | 0.5 | 0.22 | wt. % |
| antioxidant | 134PD or | America | | | |
| | Flexzone | L.P. or | | | |
| | 11L | Chemtura | | | |
| N234 | Texas N234 | Sid | 5 | 2.17 | wt. % |
| Carbon | | Richardson | | | |
| black | | | | | |

| | |
|---|---|
| Total | Total weight |
| phr: 230.9 | percent: 100.0 |

Column 1 shows the components of the rubber composition. The 13 percent treated functionalized silica is made from untreated silica with Si69 as a first silane coupling agent and a second silane coupling agent known as OTES from Gelest.

Column 2 shows trade names of the components of the rubber composition.

Column 3 shows a vendor of the components of the rubber composition.

Column 4 shows a phr of the components of the rubber composition.

Column 5 shows a weight percent of the components of the rubber composition.

The final row shows the total phr and the total weight percent. For example, the NBR latex can be a Lion emulsion NBR latex available from Lion Copolymer, LLC, and can have a phr of 100 and a weight percent of 43.31. The NBR latex can have 35 percent bound AN with a Mooney viscosity of 50 as determined by the ML 1+4 at 100 degrees Celsius.

Table 3 depicts components of an example of a rubber composition made with natural rubber (NR) as the rubber component:

TABLE 3
NATURAL RUBBER MASTERBATCH EXAMPLE

| | | | | Column 5 - | |
|---|---|---|---|---|---|
| | | | | weight percent | |
| Column 1 - | Column 2 - | Column 3 - | Column 4 - | of the rubber in | |
| component | trade name | vendor | phr | the masterbatch | |
| NR latex | | | 100 | 43.31 | wt. % |
| 13% treated | Si69/OTES | Evonik/ | 90.4 | 39.15 | wt. % |
| silica | | Gelest | | | |
| Staining oil | Hyprene | Process Oils, | 35 | 15.16 | wt. % |
| extender | BO300 | Inc. | | | |
| staining | Santoflex | Flexsys | 0.5 | 0.22 | wt. % |
| antioxidant | 134PD or | America | | | |
| | Flexzone | L.P. or | | | |
| | 11L | Chemtura | | | |
| N234 | Texas N234 | Sid | 5 | 2.17 | wt. % |
| Carbon | | Richardson | | | |
| black | | | | | |

| | |
|---|---|
| Total | Total weight |
| phr: 230.9 | percent: 100.0 |

Column 1 shows the components of the rubber composition. The 13 percent treated functionalized silica is made from untreated silica with Si69 as a first silane coupling agent and a second silane coupling agent known as OTES from Gelest.

Column 2 shows trade names of the components of the rubber composition.

Column 3 shows a vendor of the components of the rubber composition.

Column 4 shows a phr of the components of the rubber composition.

Column 5 shows a weight percent of the components of the rubber composition.

The final row shows the total phr and the total weight percent.

For example, the staining oil can be Hyprene BO300 available from Process Oils, and can have a phr of 35 and a weight percent of 15.16. In one or more embodiments, the NR latex can have a Mooney viscosity of 50 as determined by the ML 1+4 at 100 degrees Celsius.

While these embodiments have been described with emphasis on the embodiments, it should be understood that within the scope of the appended claims, the embodiments might be practiced other than as specifically described herein.

1. A method for making a functionalized silica in a dry process comprising:
dry mixing a first silane coupling agent with a silica forming a functionalized silica, the first silane coupling agent comprising:
an organosilane derived from an organic silane having the structure: Z₁Z₂Z₃Si(CH₂)_{y}X(CH₂)_{y}SIZ₁Z₂Z₃, and Z₁, Z₂, and Z₃ are each independently selected from the group consisting of a hydrogen, an alkoxy, a halogen, and a hydroxyl, having the formula: 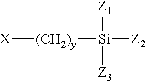
and wherein X is a functional group, including at least one of: an amino group, a polyamino alkyl group, a mercapto group, a polysulfide, a thiocyanoto group, an epoxy group, a halogen, an acryloxy group, a vinylic, a cycloalkyl, an aliphatic, an aromatic, and a methacryloxy group and the Y is an integer equal to or greater than 0;
while simultaneously dry mixing a second silane coupling agent with the silica having the first silane coupling agent, the second silane coupling agent comprising:
an organosilane derived from an organic silane having the structure: Z₁Z₂Z₃Si(CH₂)_{y}X(CH₂)_{y}SIZ₁Z₂Z₃, and Z₁, Z₂, and Z₃ are each independently selected from the group consisting of: a hydrogen, an alkoxy, a halogen, and a hydroxyl, having the formula: 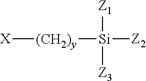
and wherein X is a functional group, including at least one of: an amino group, a polyamino alkyl group, a mercapto group, a polysulfide, a thiocyanoto group, an epoxy group, a halogen, an acryloxy group, a vinylic, a cycloalkyl, an aliphatic, an aromatic, and a methacryloxy group and the Y is an integer equal to or greater than 0; and
mixing the plurality of silanes with the silica for an amount of time, and at a temperature, to form the functionalized silica in a dry process.

2. The method of claim 1, wherein the functionalized silica comprises an organosilane attached to a surface of the silica.

3. The method of claim 1, wherein the silica has a specific surface area ranging from 100 m2/gm to 300 m2/gm, as measured by the Brunauer-Emmett-Teller analysis.

4. The method of claim 1, wherein the silica is a fumed silica or a precipitated silica.

5. The method of claim 1, wherein X is a vinyl group and Y is an integer greater than zero.

6. The method of claim 1, wherein the Z1, Z2, and the Z3 are each independently selected from the following: a hydrogen, a C1-C18 alkyl, an aryl, a cycloalkyl, an aryl alkoxy, and a halo-substituted alkyl, and at least one of Z1, Z2, and the Z3 is an alkoxy, a hydrogen, a halogen, or a hydroxyl.

7. The method of claim 1, comprising simultaneously adding a third silane coupling agent while the first and second silane coupling agents are added to the silica.

8. The method of claim 7, wherein the third silane coupling agent is an ethanol free silane.

9. The method of claim 1, wherein the first and second silane coupling agents are used in a 1:1 ratio.

10. The method of claim 1, wherein the first and second silane coupling agents are at least two different organosilanes.

11. The method of claim 1, wherein the functionalized silica has from 4 weight percent to 25 weight percent of the organosilane per 100 weight percent of an untreated silica.

12. The method of claim 1, comprising adding 0.1 weight percent to about 10 weight percent of an acid or a base based on the total weight percent of the functionalized silica during mixing to act as a catalyst to create the functionalized silica.

13. The method of claim 12, comprising blending the acid or the base into the silica prior to adding the plurality of silane coupling agents.

14. A method to make a silica rubber masterbatch component with a functionalized silica component in a wet process for incorporation into an emulsion of a rubber component comprising:
a. adding the functionalized silica to an emulsion of a rubber component;
b. simultaneously adding 0.1 parts per hundred (phr) to about 35 phr of an oil extender based on the total weight of the masterbatch to the functionalized silica in the emulsion of rubber component;
c. simultaneously adding 0.2 weight percent to 1 weight percent of an antioxidant to the functionalized silica in the emulsion of rubber component with the oil extender, and
d. mixing the added components and coagulating under heat and an adjusted pH, forming the silica rubber masterbatch component.

15. The method of claim 14, wherein the rubber component in emulsion is at least one of:
a. a natural rubber;
b. a thermoplastic rubber; and
c. a synthetic rubber, wherein the synthetic rubber consists of at least one of: an acrylonitrile butadiene rubber, an acrylonitrile butadiene styrene rubber, a carboxylated styrene butadiene rubber, a carboxylated acrylonitrile butadiene rubber, a styrene butadiene rubber, an acrylonitrile butadiene rubber, a polybutadiene rubber, a polyisoprene rubber, a polybutadiene isoprene rubber, a polymer of a conjugated diene, and a polymer of a vinyl monomer.

16. The method of claim 15, wherein the polymer of the vinyl monomer or the polymer of the conjugated diene is a polyvinylchloride, a styrene acrylonitrile copolymer, or blends thereof.

17. The method of claim 15, further comprising simultaneously adding at least one of:
a. 0.5 weight percent to 25 weight percent of a colorant based on the total weight of the masterbatch;
b. 0.5 weight percent to 30 weight percent of a carbon black based on the total weight of the masterbatch; and
c. 1 weight percent to 50 weight percent of a filler based on the total weight of the masterbatch.

18. The method of claim 17, wherein the fillers are at least one of: a talc, a clay, and a recycled rubber.

19. The method of claim 14, wherein the mixing is performed in at least one of: a ribbon mixer, an extruder, a stirred tank, a continuously stirred tank reactor, an expeller, and a devolatilizer.

20. The method of claim 1, wherein the mixing is performed in at least one of: a sigma mixer, a ribbon blender, and a low shear mixer.
